(19) United States
(12) Patent Application Publication
(10) Pub. No.: US 2015/0251714 A1
(43) Pub. Date: Sep. 10, 2015

(54) TRACKED ROLLING SET

(71) Applicant: BREVETS G5 SARL, Paris (FR)

(72) Inventor: Franck Guigan, Paris (FR)

(21) Appl. No.: 14/434,881

(22) PCT Filed: Oct. 10, 2013
(86) PCT No.: PCT/FR2013/000265

§ 371 Date: Apr. 10, 2015

(30) Foreign Application Priority Data
Oct. 12, 2012 (FR) 12/02733
Nov. 5, 2012 (FR) 12/02954

(51) Int. Cl. B62D 55/075; B62D 55/02; B62D 55/104; B62D 55/065; B62D 55/116; B62D 55/24; B62D 55/06

(52) U.S. Cl. CPC B62D 55/075; B62D 55/24; B62D 55/02; B62D 55/06; B62D 55/065; B62D 55/116; B62D 55/104

(57) ABSTRACT

A rolling element that touches the ground only via a limited contact area, offering the same advantages of comfort and handling as large diameter wheels, but occupying a far smaller amount of space. The track cooperates with a main roller and at least one secondary roller, the axes of rotation of which are distant by a constant distance, the tracks touching the ground only when the vehicle encounters an obstacle because they cooperate with a roller, the diameter of which is small enough to keep them off the ground when the vehicle is resting on its wheels.

### TECHNICAL FIELD

The present invention is a rolling element whose area of contact with the ground is minimal, to save energy and improve operability. In some embodiments, a vehicle equipped with one or more such elements is however capable to move on uneven or soft surfaces, or even on water.

### PROBLEM

Tracked vehicles usually rest on the ground by a track portion that goes at least from a front wheel to a rear wheel to have sufficient longitudinal stability. This results in high friction. The primary objective of the present invention is to benefit from the advantages of the tracks without this disadvantage. In addition, the present invention allows the use of wheels and/or rollers of small size, without that it causes a discomfort or difficulty in overcoming obstacles. Another expected benefit is the reduction of the space occupied by the wheels and their cost.

### PRIOR ART

Are known many types of tracks, but all have the disadvantage of a large friction surface between the track and the ground.

### DISCLOSURE OF THE INVENTION

The present invention is a rolling element comprising a main roller 1, a secondary roller 2 and a track 100 cooperating with these two rollers, characterized by the fact that the axis of rotation of the said secondary roller 2 is mobile while remaining at a constant distance of the axis of rotation of the said main roller.

### BRIEF DESCRIPTION OF DRAWINGS

The invention will be better understood, and other goals, features and advantages thereof will appear more clearly on reading the description that will follow, which is illustrated by FIGS. 1 to 13 that all represent rolling elements according to the invention.

FIG. 1 is a perspective view of a rolling element according to the invention. It shows a main roller 1 and two secondary rollers 2 and 3 which all three cooperate with a track 100. The distance between the axis of rotation of the main roller on the one hand and those of the secondary rollers 2 and 3 on the other hand are held constant because the axes of rotation of the secondary rollers are fixed at the end of an arm, respectively 7 and 9, itself in rotation around the axis of rotation of the main roller 1.

FIG. 2 is a perspective view of a rolling element according to the invention, comprising a platform 5 that rotates around the axis of rotation of the main roller 1, and an element called handlebar 1000 which can also rotate around the axis of rotation of the main roller 1. This handlebar 1000 is made of two parts 1000A and 1000B, and it is by pressing in different ways on this handlebar that the user controls the machine. The user can be positioned on the platform 5, or on the ground while using the machine to carry loads.

FIGS. 3 to 9 are perspective views of a rolling element identical to the one shown in FIG. 2, in different configurations to adapt to the ground.

FIG. 10 is a perspective view of a rolling element under a variant of the one shown in FIG. 1. The arms 7 and 9 are here telescopic, the arm 7 comprising a sliding part 7b sliding in a part 7a, and the arm 9 comprising a sliding part 9b sliding in part 9a.

FIGS. 11 and 12 are perspective views of an rolling element according to the invention, comprising two wheels tires 1pA and 1pB, two tracks 100A, and 100B cooperating respectively with rollers 1gA 2A and 3A and 1gB 2B and 3B.

In a configuration known as “free track” shown in FIG. 11 the wheels equipped with tires that are motorized do not cooperate with rollers 1gA and 1 gB, while in FIG. 12 the wheels equipped with equipped with tires are moved to rub on the rollers 1gA and 1 gB, so that these rollers are put in motion together with to the tracks 100a and 100B.

FIG. 13 represents a holonomic platform composed of three rolling elements 151, 152 and 153 according to the invention, connected together by three ball joints respectively 1511 1521 and 1531 to a tubular chassis 160.

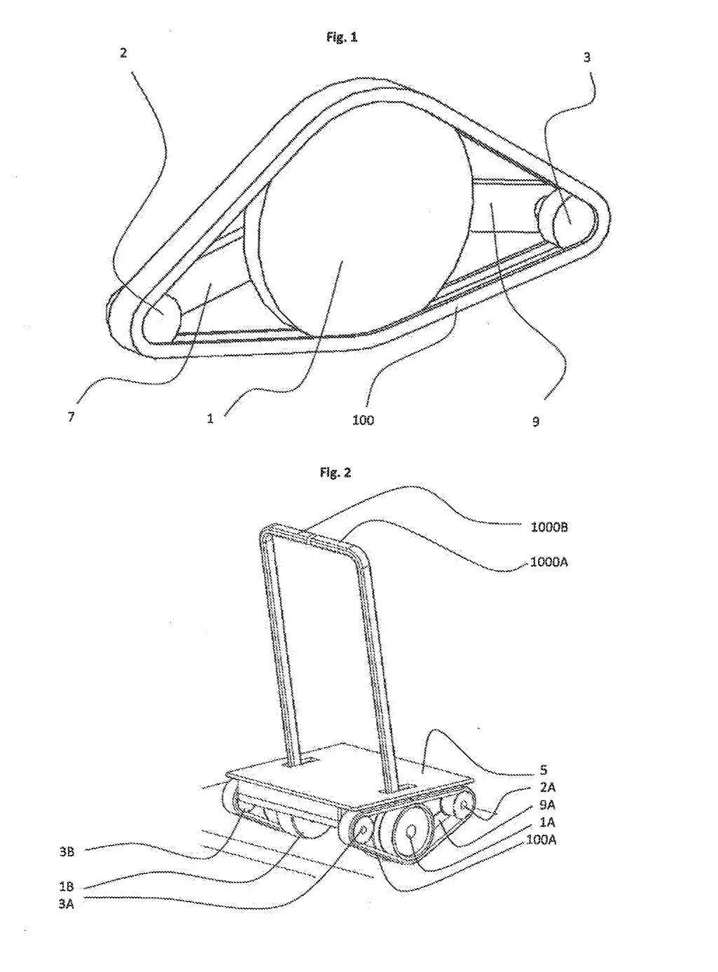

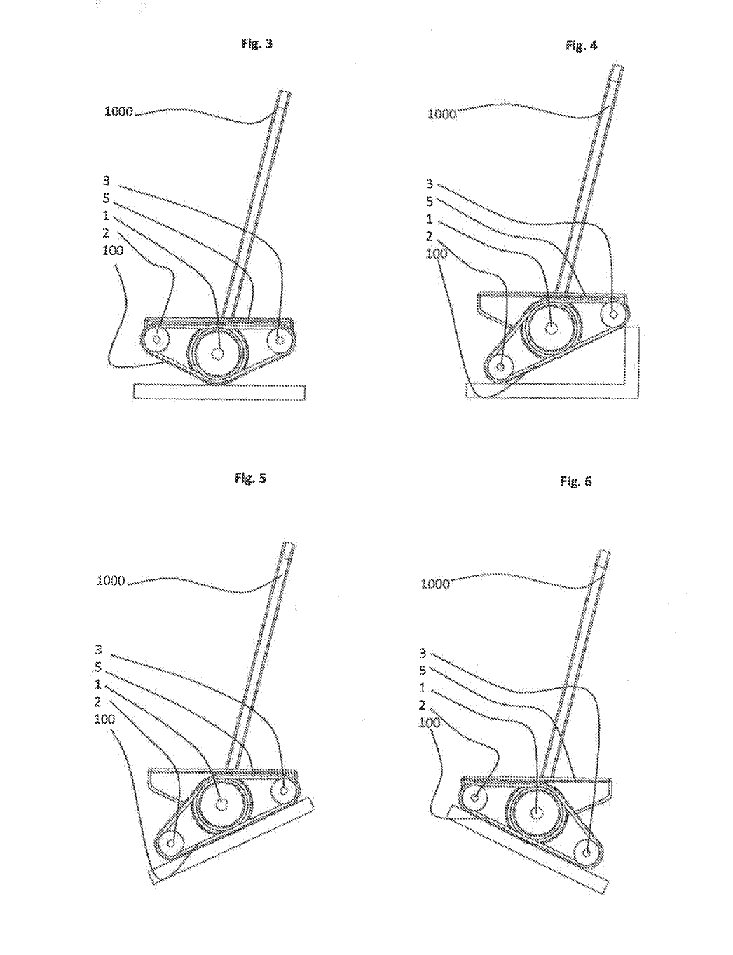

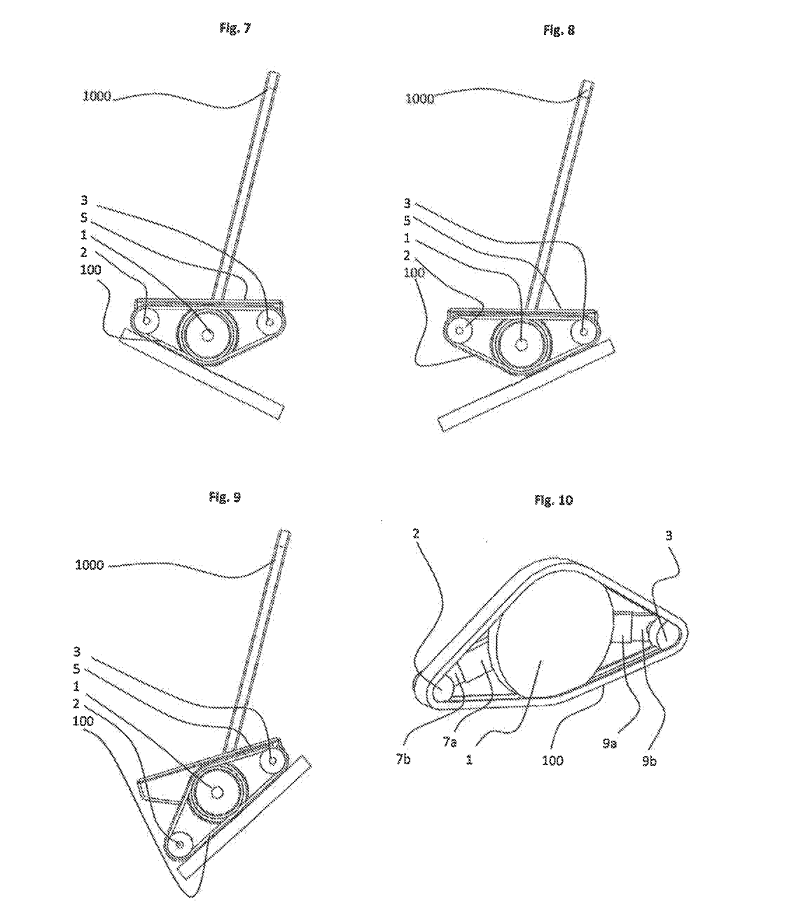

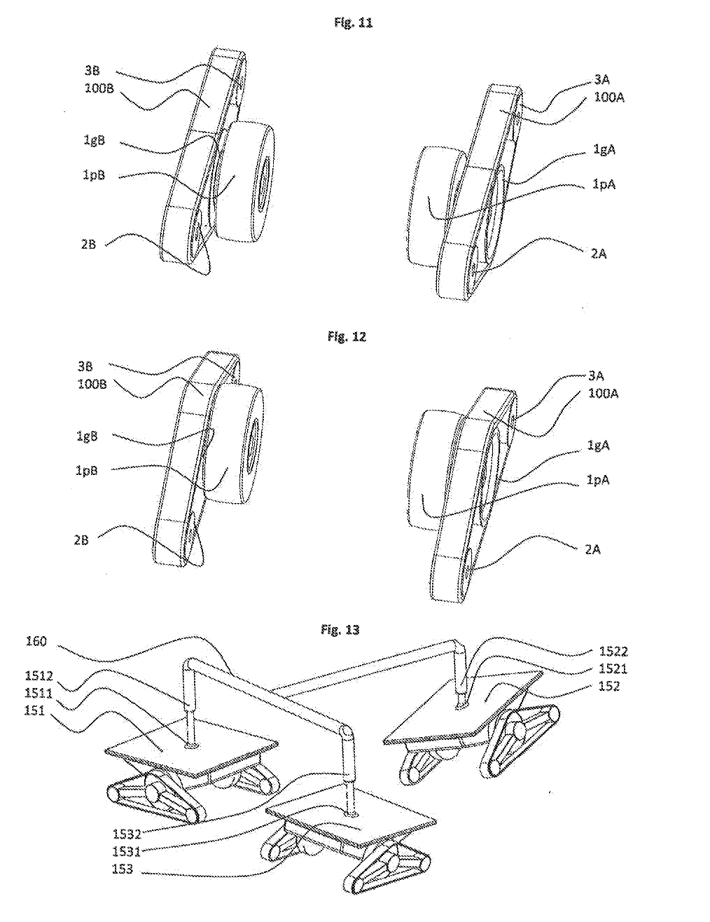

### DETAILED DESCRIPTION OF THE INVENTION

The vehicles according to the invention have the advantages of tracked vehicles for the possibilities of crossing, but the tracks have a limited surface of contact with the ground, thereby limiting friction and therefore the running resistance.

The invention therefore allows making all types of vehicles such as automobiles, with a very simple and economical design. It also allows new and more aesthetic designs than current designs of motorcycles and automobiles.

The invention thus allows to replace a wheel by a rolling element comprising a track which is in contact with the ground by a part of a so-called ground cooperation surface 10, and which comprises parts located forward and aft said ground cooperation surface that have the function of portions of a larger diameter wheel that the track replaces.

Advantageously, said track 100 rests on the ground by a surface or a set of so-called elementary around cooperation surfaces 10 whose total length is less than or equal to 20% of the total length of the track.

The rolling element may include a second secondary roller 3 having an axis of rotation which is also mobile while remaining at a constant distance from the axis of rotation of the said principal axis.

The rolling element may be equipped with a handlebar rotating around the axis of the said main roller 1. This allows more possibilities for adapting to the ground as shown in FIGS. 3 to 9. Advantageously, the inclination of said handlebar with respect to the horizontal is maintained substantially constant when said rolling element rolls on a road that rises or descends, so that the user can have a comfortable position that is independent of the shape of the ground. An electronic controller then provides the information to the engine allowing it to modify the angle of the handlebar relative to the ground, using information obtained from a sensor indicating the vertical, and/or a gyroscope and/or an accelerometer, and/or or any other known type of sensor. The rolling element may comprise a platform 5 that pivots around the main axis of the said main roller 1. This platform is advantageously equipped with two ground proximity sensors placed respectively at the front and rear of said rolling element. These proximity sensors allow control electronics to determine the distance from the platform to the ground at the front and at the rear of the platform, to optimize the position of the platform based on the geometry of the ground. All types of sensors can be used by the control electronics, and it may use all kinds of programs to manage the acceleration of the vehicle, and/or the position of the handlebar, and/or that of the platform, and/or those of the front and rear secondary rollers 2 and 3, without departing from the scope of the present invention,

Advantageously, the inclination of the said platform is maintained substantially constant relative to the plane of the road as it can be analyzed by both ground proximity sensors placed respectively at the front and rear of the said rolling element.

An improvement shown in FIG. 10 is that the arm 7 and 9 are telescopic, and can lengthen or shorten either elastically or on command. This allows on the one hand to achieve an elastic suspension to better absorb obstacles, but also to increase stability when climbing or descending stairs, stretching the lower arm and shortening so the arm to the highest optimize the position of the polygon of lift relative to the centre of gravity of the vehicle and its load.

Such a rolling element remains a rolling element according to the invention because the axis of rotation of the said secondary roller 2 remains at a constant distance from the axis of rotation of the said main roller 1 in many occasions.

Advantageously, lengthening or shortening of one arm automatically compensates the shortening or lengthening of the other arm.

In advanced mode, the rolling element is equipped with a wheel that can rotate around the axis of the said main roller 1. This wheel can be motorized.

An improvement consists in that the distance between said wheel and said roller can be changed between a configuration known as “motorized track” in which said wheel touches said roller and a so-called “free track” configuration in which said wheel does not touch said roller. The decrease in altitude of at least one secondary roller 2 or 3 results in the passage in the said “motorized wheel” configuration.

The invention is also a vehicle equipped with one or more of such rolling elements. The rolling elements according to the invention can replace all existing vehicle wheels.

Such vehicles may have four degrees of freedom as the vehicle of FIG. 13, consisting of three rolling elements 151, 152 and 153 according to the invention, connected together by three ball joints respectively 1511 1521 and 1531 to a tubular chassis 160, which includes vertical telescopic arms 1512 1522 and 1532.

Such a vehicle is not only holonomic since it can move in all directions with its three degrees of freedom on a flat surface (two for the translation to the front and rear or towards left or right, and one for the rotation to the right or to the left), but it can also place its chassis 160 to the horizontal or in practically any other plane nearly horizontal regardless of the terrain shape.

### Applications

They concern all vehicles: skates, scooters motorized or not, wheelchairs, golf cars, wagons, farm tractors, construction or military equipment, automobiles, trucks, boats and boat trailers, planes, toys, etc.

1-15. (canceled)

16. A rolling element comprising a main roller, a secondary roller and a track cooperating with these two rollers, wherein the axis of rotation of the said secondary roller is fixed at the end of an arm itself in rotation around the axis of rotation of the main roller, and by the fact that, at least in one possible configuration, the said track rests on the floor by a surface or set of so-called elementary ground cooperation surfaces whose total length is less than or equal to 20% of the total length of the said track.

17. The rolling element according to claim 16 wherein the said track cooperates continuously with the top and the bottom of the said main roller.

18. The rolling element according to claim 16, wherein it has a second secondary roller attached to the end of an arm itself in rotation around the axis of rotation of the main roller.

19. The rolling element according to claim 16 wherein said arm is equipped with an elastic suspension to better absorb the obstacles.

20. The rolling element according to claim 19 wherein the elastic suspension to better absorb obstacles is obtained by the fact that the said arm is telescopic.

21. The rolling element according to claim 16 wherein it is equipped with a wheel that can support the said rolling element.

22. The rolling element according to claim 21 wherein the said wheel rotates around the axis of rotation of the said main roller.

23. The rolling element according to claim 6 wherein it can move from a configuration so called driven track in which said main roller rotates with the said wheel to a configuration so called free track in which said main roller does not rotate with the said wheel.

24. The rolling element according to claim 23 wherein the said wheel is powered and that the distance between the said wheel and the said roller can be changed between the said driven track configuration in which the said wheel touches the said roller and the said free track configuration in which said wheel does not touch said roller.

25. The rolling element according to claim 23 wherein a modification of the altitude of at least a secondary roller results to the passage in the said driven track mode.

26. A vehicle wherein it comprises a rolling element according to claim 16 and a platform that may rotate around the axis of rotation of the said main roller.

27. The vehicle wherein it comprises a rolling element according to claim 16, and by the fact that it is equipped with one or more sensors and an electronic control unit to manage the position of a said secondary roller and/or the inclination of the said platform in the case where there is an inclinable platform, or the acceleration of the vehicle in the case where it is powered.

28. The vehicle according to claim 26 wherein it is equipped with a handlebar rotating around the axis of rotation of the said main roller.

29. The vehicle according to claim 28 wherein said handlebar inclination to the horizontal is kept relatively constant when the vehicle is driving on a ground that ascends or descends.

30. The vehicle according to claim 26 wherein the inclination of the said platform is maintained substantially constant relatively to the plane of the road as it can be parsed by one or more sensors.

31. The vehicle according to claim 30 wherein those sensors are ground proximity sensors placed respectively at the front and rear thereof rolling element.

32. The vehicle equipped with three rolling elements according to claim 16, wherein such rolling elements are connected by three ball joints to a chassis.

33. The vehicle according to claim 29 wherein said chassis comprises telescopic arms.
